(19) United States
(12) Patent Application Publication
(10) Pub. No.: US 2004/0101349 A1
(43) Pub. Date: May 27, 2004

(54) Fastening element

(76) Inventor: Fritz Weisser, St. Georgen (DE)

Correspondence Address: Joseph S Tripoli, Thomson Multimedia Licensing Inc, Patent Operations, CN 5312, Princeton, NJ, 08543-0028, US

(21) Appl. No.: 10/415,016

(22) PCT Filed: Oct. 15, 2001
(86) PCT No.: PCT/EP01/11869

(30) Foreign Application Priority Data
Oct. 27, 2000 (DE) 100 53 588.7

(51) Int. Cl. F16B 1/00

(52) U.S. Cl. 403/24

(57) ABSTRACT

The invention specifies a possible fastening means which can be used to position components precisely, in a straightforward and permanent manner, in the body of a unit, to be precise relative to stop surfaces for the component which are formed in the unit body.

This is achieved according to the invention by a fastening element (1) which has a plurality of retaining sections (18, 19, 20) which are oriented in different directions in space and via which the component (2) is pressed against the stop surfaces (11, 12) if the fastening element (1) is fixed in the envisaged position in the body of the unit (3), at least one of the retaining sections (18, 19, 20) being connected resiliently to the rest of the fastening element (1).

The invention relates to a fastening element for adjusting a component in a unit, a position for fixing the fastening element being provided, and a plurality of stop surfaces for the component which are oriented in different directions in space being formed, in the body of the unit.

It is often necessary in practice for certain components of a unit to be positioned very precisely in the unit body, with the result that they assume a defined position relative to other components of the unit. An example which may be mentioned here is the arrangement of optical components, e.g. beam splitters, mirrors and lenses, in the beam path of optical units, for example units for recording or reproducing information on optical recording media.

In optical pickups which are used in CD and DVD players, a beam splitter, for example, is arranged such that it allows the laser beam emitted by a laser diode to pass through, with the result that said laser beam can come into contact with an optical data carrier and be reflected there. Moreover, the beam splitter is also intended to be arranged such that the beam coming back from the data carrier is reflected and thus guided to a detector. For positioning and fixing the beam splitter, in the case of known optical pickups, use is made of a clamping device which usually has at least one spring for each direction in space. The component is pressed, via the springs of the clamping device, onto the stop surfaces for the component which are formed in the unit body. Since such clamping devices are made up of a number of parts, the installation of the beam, splitter, in conjunction with the assembly of the clamping device, involves very high outlay. Moreover, when use is made of clamping devices with a plurality of springs which are independent from one another, it frequently proves problematic to keep the component in its desired position permanently, i.e. throughout the service life of the unit. It is also known from the prior art to fix the beam splitter in the unit body with the aid of adhesive. However, permanently reliable fixing cannot be achieved in this case either.

The object of the present invention, then, is to specify a possible fastening means which can be used to position components precisely, in a straightforward and permanent manner, in the body of a unit, to be precise relative to the stop surfaces for the component which are formed in the unit body.

This object is achieved by features specified in independent claims. Advantageous configurations are specified in dependent claims.

The fastening element is characterized by a plurality of retaining sections which are oriented in different directions in space and via which the component is pressed against the stop surfaces if the fastening element is fixed in the envisaged position in the body of the unit, at least one of the retaining sections being connected resiliently to the rest of the fastening element.

Taking the prior art as the departure point, it has been found first of all that springs are basically suitable for positioning and fixing certain components in the body of a unit if corresponding stop surfaces for the component are formed in the unit body. It has also been found that it is not absolutely necessary to have a plurality of springs for pressing a component onto the corresponding stop surfaces in the unit body, to be precise even when the stop surfaces are oriented differently in space. This is because it has been found, according to the invention, that it is also possible for a component to be pressed against differently oriented stop surfaces by a single fastening element designed as a spring element if the three-dimensional formation of the fastening element is adapted to the geometry of the component and the orientation of the stop surfaces. The fastening element according to the invention thus comprises a plurality of retaining sections which are oriented in different directions in space—corresponding to the stop surfaces—and of which at least one acts like a spring element. Using retaining sections advantageously achieves the situation where optical subassemblies are fastened without their optical action being impaired.

The use of a single fastening element for positioning and fixing a component in the body of a unit results in a considerable simplification in installation. It also proves advantageous that this type of fixing is very permanent, with the result that it is possible to assume a precise position of the component in the unit body despite mechanical and thermal loading throughout the service life of the unit.

As far as straightforward and cost-effective production is concerned, it proves advantageous if the fastening element according to the invention is formed in one piece. For this purpose, it is produced by bending, for example, from a suitable spring steel.

As has already been mentioned, a position for fixing the fastening element according to the invention has to be provided in the body of the unit in which the component is to be adjusted. It proves advantageous in this context if the fastening element has an installation section via which it is secured in the unit body. The geometry of the installation section will usually be reflected in the design of the unit body by the formation, for example, of abutment edges for the installation section, such edges additionally simplifying the installation of the fastening element.

In an advantageous variant of the fastening element according to the invention, all the retaining sections are connected resiliently to the installation section. This results in the component being fixed uniformly in all directions in space. Moreover, in this case, precise positioning of the component is ensured even in the case of production-related dimensional tolerances of the fastening element and, if appropriate, also of the component. It is possible to compensate for such dimensional tolerances in all directions in space by the retaining sections, which are connected resiliently to the installation section.

In terms of a straightforward installation of the fastening element together with the component, it is advantageous if a lead-through for a screw is formed in the installation section, with the result that the fastening element can be screwed tight in the unit body. With corresponding orientation of the installation section and of the retaining sections of the fastening element, it is possible, as the fastening element is screwed in, for the component to be moved into its desired position in the unit body and pressed against the stop surfaces.

There are various possible ways, in principle, of advantageously configuring and developing the teaching of the present invention. For this purpose, you are referred, on the one hand, to the claims subordinate to Patent Claim 1 and, on the other hand, to the following explanation of an exemplary embodiment of the invention with reference to the drawings, in which:

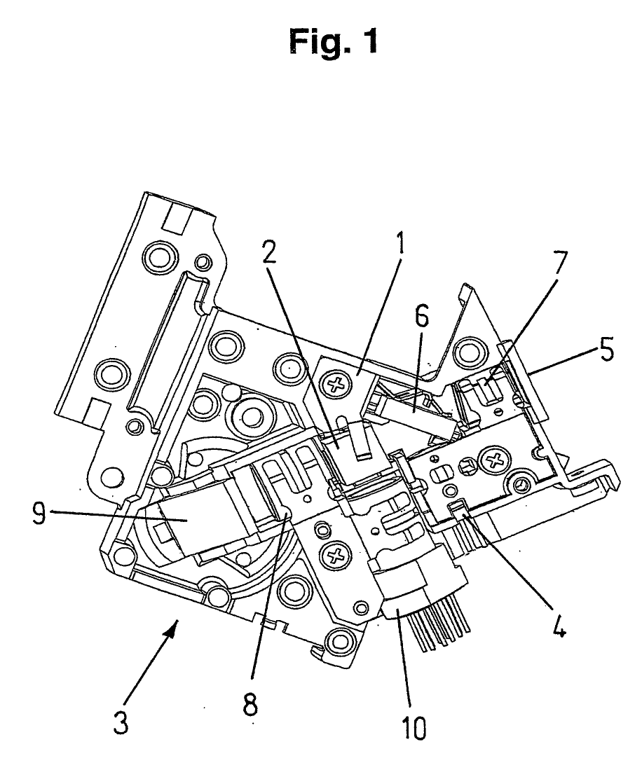

FIG. 1 shows the arrangement of a beam splitter in an optical pickup with the aid of a fastening element according to the invention,

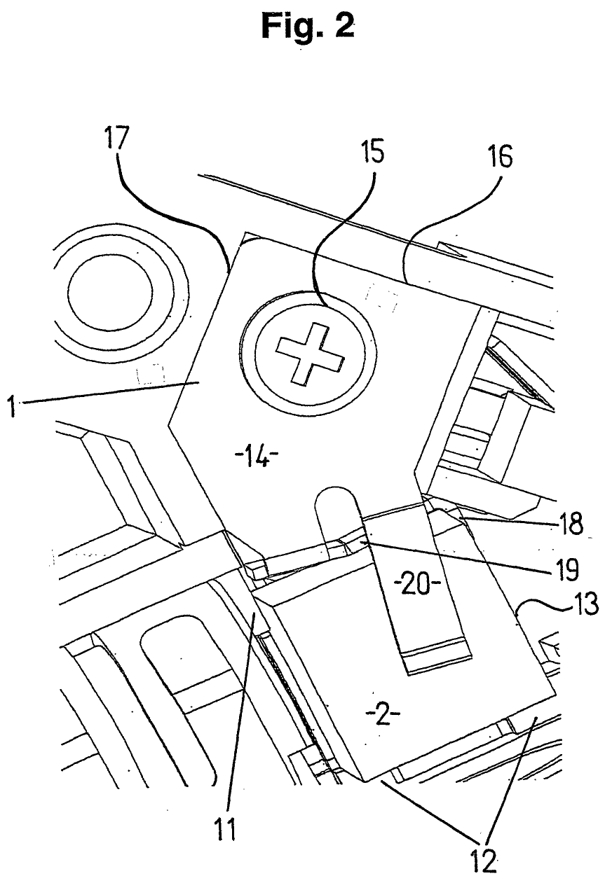

FIG. 2 shows an enlarged detail from FIG. 1 with the beam splitter and the fastening element, and

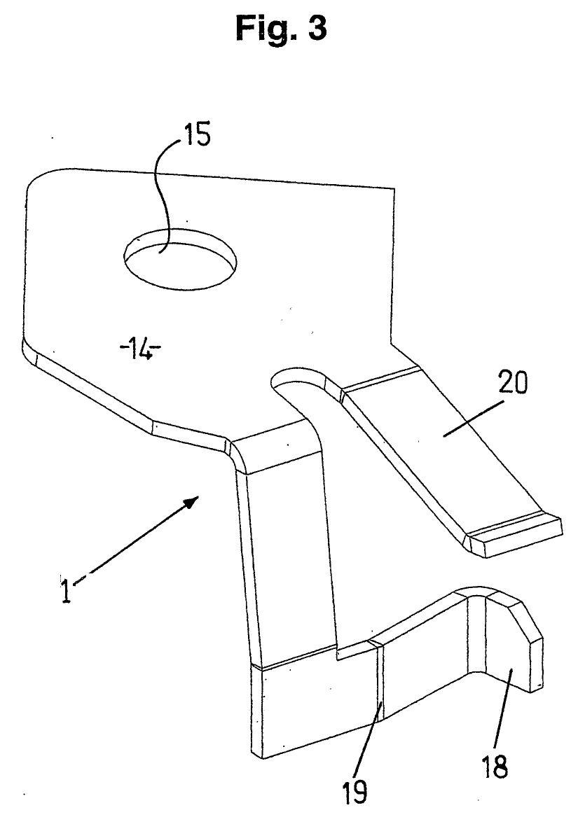

FIG. 3 shows, on its own, the fastening element illustrated in FIGS. 1 and 2.

FIG. 1 illustrates the use of a fastening element 1 according to the invention for adjusting an optical component, namely a beam splitter 2, in the beam path of a pickup 3 in a unit for recording or reproducing information on optical recording media.

The pickup 3 illustrated here is a DVD pickup, which may be operated both in DVD mode and in CD mode. In DVD mode, use is made of a laser diode 4 and a detector 5. The laser beam emitted by the laser diode 4 is reflected on a semireflective mirror 6 and passes through the beam splitter 2. The latter also serves for reflecting the beam coming back from the disk and deflecting it to the detector 5. In this case, the beam passes through the semireflective mirror 6 and is focused with the aid of a lens 7. 8 designates a collimator and 9 designates a mirror which is likewise arranged in the beam path of the pickup 3. In CD mode, use is made of a hologram 10.

FIG. 2 illustrates the functioning of the fastening element 1 according to the invention, while FIG. 3 represents the design thereof.

For the functioning of the fastening element 1 according to the invention, it is necessary on the one hand for a position for fixing the fastening element 1 to be provided, and on the other hand for a plurality of stop surfaces for the beam splitter 2 which are oriented in different directions in space, and are designated 11 and 12 here, to be formed, in the body of the optical pickup 3.

In the exemplary embodiment illustrated here, the fastening element 1 is fixed on the optics body 13 of the optical pickup 3. For this purpose, the fastening element 1 has an installation section 14 with a screw lead-through 15. The position of the installation section 14 on the optics body 13 is defined, correspondingly, by a screw hole and two additional abutment edges 16 and 17 in the optics body 13. With the aid of the abutment edges 16 and 17, the installation section 14, and thus the entire fastening element 1, is aligned in a defined manner as the fastening element is screwed tight.

In the exemplary embodiment illustrated here, the fastening element 1 comprises three retaining sections 18, 19 and 20 which are oriented in different directions in space. These retaining sections 18, 19 and 20 are connected resiliently to the installation section 14.

In accordance with the cuboidal shape of the beam splitter 2 which is to be positioned and fixed and with the orientation of stop surfaces 11 and 12, the retaining sections 18 and 19 are formed at right angles to one another, with the result that they engage around a corner edge of the beam splitter 2. The spring forces of the retaining sections 18 and 19 press the beam splitter 2 against the stop surfaces 11 and 12. The retaining sections 20 exerts a spring force essentially perpendicularly to the spring forces of the retaining sections 18 and 19 and presses the beam splitter 2 against the optics body 13 in this way.

The precise alignment, i.e. the adjustment, of the beam splitter 2 takes place during the installation of the fastening element 1, and more specifically as the latter is screwed tight. For this purpose, the beam splitter 2 is first of all arranged between the retaining sections 18, 19 and 20 of the fastening element 1. As the fastening element 1 is screwed tight, the beam splitter is then automatically moved, and pressed, against the stop surfaces 11 and 12 by the retaining sections 18 and 19. Finally, the beam splitter 2 is also pressed against the optics body 13 by the retaining section 20, with the result that the beam splitter 2 is fixed permanently, and aligned precisely, in all three directions in space.

FIG. 3 shows that, in the exemplary embodiment illustrated here, the fastening element 1 is formed in one piece.

1. Fastening element (1) for adjusting a component (2) in a unit (3),
a position for fixing the fastening element (1) being provided, and
a plurality of stop surfaces (11, 12), for the component (2) which are oriented in different directions in space being formed, in the body of the unit (3),
characterized in that the fastening element (1) is formed in one piece and by three retaining sections (18, 19, 20) which are oriented in different directions in space and via which the component (2) is pressed against the stop surfaces (11, 12) if the fastening element (1) is fixed in the envisaged position in the body of the unit (3), at least one of the retaining sections (18, 19, 20) being connected resiliently to the rest of the fastening element (1).

2. Fastening element (1) according to claim 1, characterized by an installation section (14) via which the fastening element (1) is fixed in the body of the unit (3).

3. Fastening element (1) according to claim 2, characterized in that the retaining sections (18, 19, 20) are connected resiliently to the installation section (14).

4. Fastening element (1) according to either of claims 2 and 3, characterized in that a lead-through (15) is formed in the installation section (14), with the result that the fastening element (1) can be fixed in the envisaged position in the body of the unit (3) with the aid of a screw.

5. Use of a fastening element (1) according to one of claims 1 to 4 for adjusting an optical component, in particular a beam splitter (2), in the beam path of an optical pickup (3).

6. Optical pickup (3) with a fastening element (1) for adjusting an optical component (2) according to one of claims 1 to 4.

7. Unit for recording or reproducing information on optical recording media, having a pickup (3), characterized in that an optical component (2) is fixed in the beam path of the pickup (3) with a fastening element (1) configured in one piece and for adjusting the optical component (2) in three directions.

8. Unit according to claim 7, characterized in that the fastening element (1) is configured in one piece and, for fixing the optical component (2) in three directions, has resilient retaining sections (18, 19, 20) which extend from an installation surface (14), aligned on at least one abutment surface in the pickup, of the fastening element (1) for fastening the fastening element (1) in the pickup (3).

9. Unit according to claim 8, characterized in that two of the resilient retaining sections (18, 19, 20) extend perpendicularly one after the other in each case from the installation surface (14) of the fastening element (1).
